(19) United States
(12) Patent Application Publication
(10) Pub. No.: US 2016/0067733 A1
(43) Pub. Date: Mar. 10, 2016

(54) APPARATUSES AND METHODS FOR DISPENSING PREDETERMINED QUANTITIES OF LIQUID ONTO A SUBSTRATE

(71) Applicant: Digilab, Inc., Marlborough, MA (US)

(72) Inventors: Sidney Braginsky, Dix Hills, NY (US); Richard Edward Parker, Greenfield, NH (US)

(21) Appl. No.: 14/846,621

(22) Filed: Sep. 4, 2015

Related U.S. Application Data
(60) Provisional application No. 62/045,893, filed on Sep. 4, 2014.

(51) Int. Cl. B05C 9/08; B05B 1/30; B05B 1/02

(52) U.S. Cl. CPC B05C 9/08; B05B 1/02; B05B 1/30

(57) ABSTRACT

Discussed herein are methods and apparatuses for dispensing precise quantities of reagents, wherein air pressure is controlled to pilot a liquid syringe or diaphragm that provides an air to liquid interface. The resultant pressurized liquid is then in series with dispensing element, such as an aerosol dispenser, solenoid valve or piezo dispenser. The pump may be controlled by air pressure to provide an incremental quantity or continuous flow of reagent to the dispenser. The pump and dispenser may be operated in cooperation with one another such that the quantity or flow rate of liquid dispensed by the dispenser can be precisely metered substantially independently of the particular operating parameters of said dispenser to attain a desired flow rate, droplet size or mist quality, droplet frequency or droplet velocity.

### BACKGROUND

The present technology relates generally to improved apparatuses and methods for dispensing chemical reagents and other liquids onto a substrate and, in particular, to various methods and apparatus particularly adapted for dispensing precise quantities of chemical reagents.

Current dispensing apparatuses methods are generally based on the use of either air brush dispensers or solenoid valve dispensers. Air brush dispensers use pressurized air flowing across a needle valve opening to atomize the reagent into a mist which is then deposited onto the test strip substrate. The quality of the mist, reagent dispersion pattern and the amount of reagent flow onto the substrate are controlled by adjusting the needle valve opening or the pressure of the atomizing air flow. Solenoid valve dispensers generally comprise a small solenoid-activated valve that can be opened and closed electronically at high speeds. The solenoid valve is connected to a pressurized vessel or reservoir containing the fluid to be dispensed. In operation, the solenoid is energized by a pulse of electrical current, which opens the valve for a predetermined duty-cycle or open time. This allows a small volume of liquid to be forced through the nozzle, forming a droplet which is then ejected from the valve onto the target substrate. The size and frequency of the droplets and the amount of reagent flow onto the substrate are typically controlled by adjusting the frequency and pulse-width of energizing current provided to the solenoid valve or by adjusting the pressure of the reservoir.

Other apparatuses for dispensing a liquid onto a substrate typically include a dispenser having an inlet and an outlet and a valve adapted to be opened and closed at a predetermined frequency and duty cycle to form droplets which are deposited onto the substrate. A positive displacement pump, such as a stepper-motor-operated syringe pump, may be hydraulically arranged in series with the inlet of the dispenser for metering predetermined quantities of liquid to the dispenser. The pump and dispenser are typically operated in cooperation with one another such that the quantity or flow rate of liquid dispensed by the dispenser can be precisely metered substantially independently of the particular operating parameters of said dispenser. In this manner, the size, frequency, and velocity of droplets dispensed by said dispenser can each be adjusted substantially independently of the quantity or flow rate of liquid being dispensed.

Often, however, a desired droplet size or mist quality is simply not attainable for a desired production flow rate due to the lack of closed loop pressure control which provides for absolute reading of the dispensing parameters. Certain dispensers, such as stepper motor driven syringe pumps, are also susceptible to damage or dangerous overpressure situations, as clogging in the dispensing valve itself can be a problem that remains undetected and can consequently be hazardous to the componentry or the operator. This is a major reliability problem with stepper motor operated syringe pumps dispensers.

Thus, a need exists for improved apparatuses and methods for dispensing chemical reagents and other liquids onto a substrate, that provides precise and predictable characteristics including droplet size or mist quality, while avoiding clogging, damage and dangerous overpressure situations.

### SUMMARY OF THE DISCLOSED TECHNOLOGY

In certain embodiments, the present technology is directed to an apparatus for dispensing predetermined quantities of liquid onto a substrate, the apparatus comprising: (a) a dispenser having an inlet and an outlet and being adapted to form droplets of said liquid having a predetermined size or quality which are deposited onto said substrate; and (b) a pressurized vessel hydraulically arranged in series with the inlet of said dispenser for metering predetermined quantities of said liquid to said dispenser. In certain embodiments, the quantity or flow rate of liquid dispensed by said dispenser can be precisely metered substantially independently of the particular operating parameters of the dispenser.

In certain embodiments, the dispenser comprises an aerosol dispenser having an outlet comprising an air passage terminating in a nozzle and an inlet comprising a liquid passage terminating in a venturi orifice for mixing said liquid with a flow of air to form an aerosol mist proximate said substrate. In certain embodiments, the dispenser comprises a valve adapted to be opened and closed at a predetermined frequency and duty cycle to form droplets of said liquid which are ejected onto said substrate. In various embodiments, the valve can be actuated by an electric solenoid, or by a piezoelectric constrictor device.

In certain embodiments, the valve has a frequency and duty cycle, and one or both of the frequency and duty cycle of said valve is adjusted substantially independently for a given quantity or flow rate of liquid to produce droplets of a desired size, frequency or exit velocity. In certain embodiments, the apparatus may further comprise an array of dispensers and pressure vessels, the outlets of said dispensers being arranged in a desired pattern suitable for attaining a desired print matrix or dot pattern.

In other embodiments, the present technology is directed to a method of dispensing a liquid onto a substrate comprising the steps of: metering a predetermined quantity or flow rate of said liquid using pressure displacement means; and supplying said metered quantity or flow rate of said liquid to a dispenser to form droplets of a predetermined volume or quality which are deposited onto said substrate.

In various embodiments of the apparatuses and methods discussed herein, the dispenser and pressurized vessel may be configured or adjusted to provide a range of selectable droplet sizes attainable for stable operation and varying by a factor of greater than about 250; or to provide selectable droplet sizes ranging from less than about 700 picoliters to greater than about 1 microliter.

### BRIEF DESCRIPTION OF THE FIGURES

FIG. 1 is a schematic drawing of a precision metered dispensing apparatus having features in accordance with certain embodiments of the present technology.

FIG. 2 is a representative drawing of a vessel in accordance with certain embodiments of the present technology, having a moveable element to isolate liquid and air interation.

### DETAILED DESCRIPTION

In various embodiments, the present technology provides improved apparatuses and methods for dispensing chemical reagents and other liquids onto a substrate, that provide precise and predictable characteristics including droplet size or mist quality, while avoiding clogging, damage and dangerous overpressure situations.

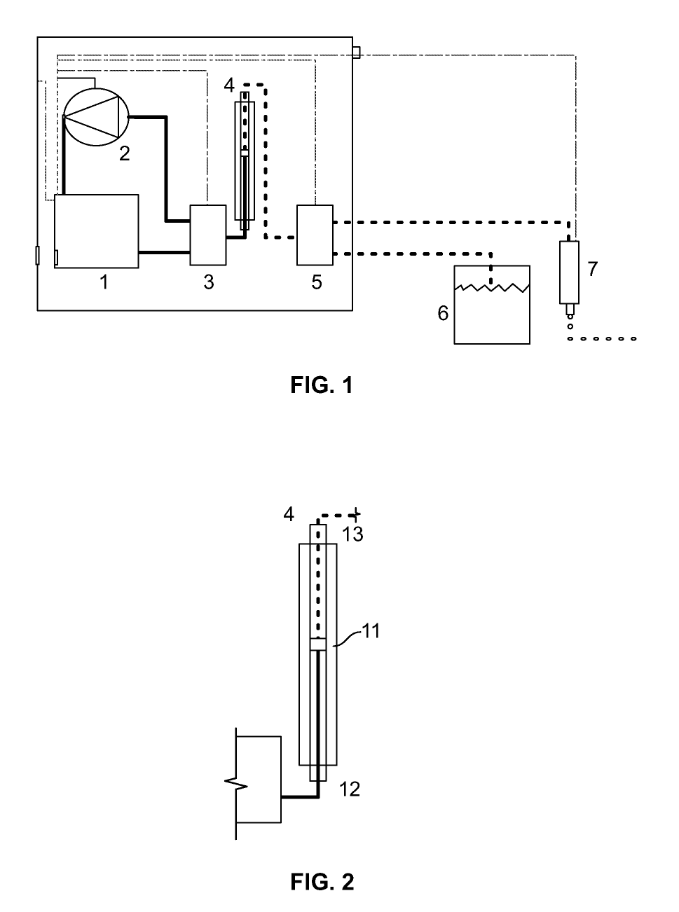

FIG. 1 is a schematic drawing of a precision metered dispensing apparatus having features in accordance with certain embodiments of the technology. The dispensing apparatus featured therein comprises a dispenser 7 that dispenses reagent from a reservoir 6 that is being controlled by air pressure or vacuum selected by first valve 3. The first valve 3 selects precision positive pressure being generated by the electronic pressure controller 1 which is supplied by a compressed air source provided externally or generated by a combination positive pressure and vacuum diaphragm pump 2. The first valve 3 may also be commanded by controller 1 to select vacuum during the aspiration phase where second valve 5 is also selected to communicate with reservoir 6 to allow reagent to be aspirated into a vessel 4. The second valve 5 can allow for communication from vessel 4 to dispenser 7 during the dispensing phase.

FIG. 2 is a representative drawing of a vessel 4 in accordance with certain embodiments to the technology. The vessel allows for precisely controlled air pressure to enter at inlet 12, which acts upon and isolating and movable membrane 11 causing it to move axially and transfer pressure and motion to liquid that has entered inlet 12 and exits as exit stream 13.

### Operation

In accordance with certain embodiments of the present technology, the reagent dispensing method and apparatus can dispense desired quantities of chemical reagents or other liquids onto a substrate while advantageously providing the ability to independently and precisely adjust droplet size or mist quality, droplet velocity and reagent flow rates, both in terms of per unit time or per unit distance. Thus, the present technology contemplates new devices and methods of dispensing precise quantities of liquids having improved performance and dynamic range of operation.

In certain embodiments, the present technology is directed to an apparatus for dispensing precise quantities of liquid onto a substrate. The apparatus may comprise a dispenser having an inlet and an outlet and being adapted to form droplets of liquid having a predetermined size or quality. The droplets may be emitted by the dispenser so as to be deposited onto a substrate. In certain embodiments, a pressure based displacement pump is provided in series, with the inlet of the dispenser for delivering a liquid to the dispenser a precise pressure. In this manner, the quantity or flow rate of liquid dispensed by the dispenser can be precisely metered given the particular operating parameters of the dispenser.

In accordance with certain embodiments, the present technology provides a method or apparatus for dispensing a reagent onto a substrate. A pressure based displacement pump can be provided in series with a reagent dispenser. The pump can be controlled to provide precision pressures that control incremental or continuous flow of reagent to the dispenser. The dispenser can be selectively operated to form droplets or a mist of droplets of a predetermined droplet size and velocity regardless of the viscosity, which are then deposited onto the target substrate.

In certain embodiments, factors including but not limited to the droplet size, mist quality, droplet velocity or flow rate of the reagent can be advantageously precisely controlled independently of the particular system operating parameters of the dispenser.

In accordance certain embodiments, the present technology is directed to an apparatus for dispensing a liquid, the apparatus comprising a dispenser having an inlet and an outlet and a valve adapted to be opened and closed at a predetermined frequency and duty cycle to form droplets which are deposited onto the substrate. A pump can be hydraulically arranged in series with the inlet of the dispenser for metering predetermined quantities of liquid to the dispenser. The pump and dispenser can be operated in cooperation with one another such that the quantity or flow rate of liquid dispensed by the dispenser can be precisely metered substantially independently of the particular operating parameters of said dispenser. In this manner, factors including but not limited to the size, frequency, and velocity of droplets dispensed by said dispenser can each be adjusted substantially independently of the quantity or flow rate of liquid being dispensed.

In certain embodiments of the present technology, a key operational advantage may be achieved, in that over a certain dynamic range the flow of reagent, droplet size or mist quality, droplet frequency, or droplet velocity may be controlled substantially independently of one another and of the particular flow characteristics of the reagent. For example, the size of droplets formed by the dispenser can be adjusted by the pump by changing the operating frequency of the dispensing valve as well as the pilot pressures. This has particular advantage, for example, in applications requiring the dispensing of very small droplets or for dispensing higher viscosity reagents, since the reagent flow can be precisely controlled without substantial regard to the system operating parameters otherwise required to achieve stable dispensing operations. Droplets of similar size can be delivered at various velocities so as not to disturb the properties of the liquid being printed or the material being printed upon. For example, this can be achieved using a high pressure and short duration of dispenser opening time or a low pressure and a long dispenser opening time. In certain embodiments, this may be critical in applications such as printing live cells where high pressure and high velocity could damage the cell structure.

The present technology overcomes these and other problems of the known apparatuses and methods by, inter alia, precisely metering the quantity or flow rate of the reagent. Advantageously, the amount of reagent can be precisely regulated over a wide dynamic range without being substantially affected by the particular operating parameters of the dispenser. This feature permits droplet size, droplet frequency, droplet velocity and other system parameters to be varied dramatically from one range to another at a given flow rate. Thus, the present technology not only provides methods for precise metering of reagent, but also adds a new dimension of operating a dispenser not before possible.

Another important operational advantage is that the range of droplet sizes attainable with the present technology is much wider than that achieved with conventional dispensers. The method and apparatus of the embodiments of the present technology using the solenoid valve dispenser, for example, can be capable of attaining minimum stable droplet sizes in the range of about 700 picoliters, compared with the range of 5-100 nanoliters for most conventional dispensers. Even smaller droplet sizes could be attainable in accordance with the present embodiments directed to apparatuses having a smaller effective orifices or higher frequency capability. Drop formation experiments have demonstrated the ability to dispense 700-nanoliter drops with very good repeatability.

Thus, the range of droplet sizes and velocity attainable for stable dispensing operation may vary by a factor of about 250 or more. This feature of the present embodiments has particular advantage for high production manufacturing and processing of biologically engineered structures such as, for example, matrices that contain Stem Cells. In certain production applications, for example, it is desirable to dispense very small droplets or fine mists of reagent to provide optimal coating characteristics. At the same time, it may be desirable to provide high reagent flow rates for increased production levels.

### Spot Dispensing

In certain embodiments of the technology, in the dot dispensing mode, individual droplets can be dispensed by synchronizing the solenoid valve and the control pressure pump. The pump can be selected to create a known pressure. The solenoid valve can be coordinated to open and close at predetermined times relative to the control pressure. The valve is typically opened for a set and adjustable period of time after the pressure is stabilized in order to get the droplet characteristics desired. While the valve is open the pressure wave pushes a volume of fluid down the nozzle forming a droplet at the exit orifice of the valve or nozzle. The droplet can have a size determined by the pressure, the valve opening time, valve characteristics and the characteristics of the liquid being dispensed. The timing and duration of each valve cycle relative to the pressure created by the pump can be determined experimentally to achieve stable dispensing operation having the desired droplet size.

### Aspirating

In certain embodiments, a mode of operation is aspirating (“sucking”) precise quantities of reagent or other liquids from a sample or reservoir. This mode may be used, for example, in a “suck and spit” operation whereby a precise quantity of fluid is aspirated from one vial containing a sample fluid and then dispensed into another vial or onto a diagnostic test strip for testing or further processing. In various embodiments, the dispenser/aspirator may be a simple nozzle or needle (“aspirating tube”) or a solenoid valve dispenser.

In certain embodiments, the tip of the dispenser or aspirating tube is placed into the fluid to be aspirated, and the pump generates a vacuum to draw a precise quantity of the fluid into the tip of the dispenser or aspirating tube. It is generally desirable to only aspirate a small volume of reagent into the tip of the solenoid valve dispenser that does not pass into the valve. In such an operation, the pump would be primed with a backing fluid, an amount of backing fluid equal to the amount of fluid desired to be aspirated would be dispensed and then the pump would aspirate the desired volume of reagent using the vacuum function.

This mode of operation has particular advantage for dispensing high viscosity reagents. Conventional solenoid valve dispensers typically do not work very well with solutions having a viscosity above about 5 centipoise. But there are many applications where it is desirable to dispense reagents having high viscosities. Advantageously, the present embodiments, when used in the aspirate/dispense mode, can provide a solution to this problem. In certain embodiments, the aspirate/dispense mode the system will be filled with a backing solution such as water or a water-based solution having a low viscosity. The reagent is first aspirated then dispensed, followed by washing of the valve by dispensing excess wash fluid.

It will be appreciated by those skilled in the art that the methods and apparatus disclosed in accordance with the present invention can be used to dispense a wide variety of liquids, reagents and other substances and a variety of substrates. Although the invention has been disclosed in the context of certain preferred embodiments, those skilled in the art will readily appreciate that the present invention extends beyond the specifically disclosed embodiments to other alternative embodiments of the invention. Thus, it is intended that the scope of the invention should not be limited by the particular disclosed embodiments described above, but should be determined only by a fair reading of the claims that follow.

1. An apparatus for dispensing predetermined quantities of liquid onto a substrate, the apparatus comprising:
(a) a dispenser having an inlet and an outlet and being adapted to form droplets of said liquid having a predetermined size or quality which are deposited onto said substrate; and
(b) a pressurized vessel hydraulically arranged in series with the inlet of said dispenser for metering predetermined quantities of said liquid to said dispenser.

2. The apparatus of claim 1, whereby the quantity or flow rate of liquid dispensed by said dispenser can be precisely metered substantially independently of the particular operating parameters of the dispenser.

3. The apparatus of claim 1, wherein the dispenser comprises an aerosol dispenser having an outlet comprising an air passage terminating in a nozzle and an inlet comprising a liquid passage terminating in a venturi orifice for mixing said liquid with a flow of air to form an aerosol mist proximate said substrate.

4. The apparatus of claim 1, wherein the dispenser comprises a valve adapted to be opened and closed at a predetermined frequency and duty cycle to form droplets of said liquid which are ejected onto said substrate.

5. The apparatus of claim 4, wherein the valve is actuated by an electric solenoid, or by a piezoelectric constrictor device.

6. The apparatus of claim 4, wherein the valve has a frequency and duty cycle, and wherein one or both of the frequency and duty cycle of said valve is adjusted substantially independently for a given quantity or flow rate of liquid to produce droplets of a desired size, frequency or exit velocity.

7. The apparatus of claim 1, wherein the apparatus further comprises an array of dispensers and pressure vessels, the outlets of said dispensers being arranged in a desired pattern suitable for attaining a desired print matrix or dot pattern.

8. The apparatus of claim 1, wherein the dispenser and pressurized vessel are configured to provide a range of selectable droplet sizes attainable for stable operation and varying by a factor of greater than about 250.

9. The apparatus of claim 1, wherein the dispenser and pressurized vessel are configured to provide selectable droplet sizes ranging from less than about 700 picoliters to greater than about 1 microliter.

10. A method of dispensing a liquid onto a substrate comprising the steps of:
(a) metering a predetermined quantity or flow rate of said liquid using pressure displacement means; and
(b) supplying said metered quantity or flow rate of said liquid to a dispenser to form droplets of a predetermined volume or quality which are deposited onto said substrate.
